(19) United States
(12) Patent Application Publication
(10) Pub. No.: US 2022/0343333 A1
(43) Pub. Date: Oct. 27, 2022

(54) Method for transmitting a complementary information relating to a financial transaction

(71) Applicant: Orange, Issy-Les-Moulineaux (FR)

(72) Inventors: François Toutain, Chatillon Cedex (FR); Emmanuel Le Huerou, Chatillon Cedex (FR)

(21) Appl. No.: 17/761,468

(22) PCT Filed: Sep. 17, 2020
(86) PCT No.: PCT/FR2020/051609

§ 371 Date: Mar. 17, 2022

(30) Foreign Application Priority Data
Sep. 20, 2019 (FR) FR1910411

(51) Int. Cl. G06Q 20/40; G06Q 20/34; G06Q 20/38

(52) U.S. Cl. CPC G06Q 20/40145; G06Q 20/341; G06Q 20/389

(57) ABSTRACT

A transmission method and transmission device for transmitting to at least one electronic address, managed by at least one server, at least one complementary information relating to at least one financial transaction carried out by a user. The method includes: receiving at least one first message relating to at least one financial transaction from a terminal, the message comprising at least one identifier of the user; determining at least one electronic address as a function of the at least one identifier; obtaining at least one complementary information; generating at least one second message including the at least one complementary information; and transmitting in a time interval the at least one second message to the at least one electronic address.

### 1. FIELD OF THE INVENTION

The invention belongs to the field of telecommunications, and relates more particularly to financial applications.

### 2. PRIOR ART

Banks nowadays offer their customers online services that make it possible for example to make transfers or to consult transaction statements from any computer or mobile terminal connected to the Internet. Although these statements are nowadays available in electronic form, the information that they contain, and in particular the content of each transaction line, has barely changed. Indeed, an account statement generally has a date of the transaction, a value date, a description of the transaction and a credit or debit amount. In addition, since the description is sometimes not that explicit, the user may have difficulty remembering the subject of the corresponding transaction. It should be noted that it is currently not possible, in online bank statements, to have a digitized invoice associated with a transaction line.

Indeed, when making a purchase from a merchant, a professional or an individual may want proof of purchase. The merchant then issues an invoice, usually on paper, which is given to the buyer once payment is complete. The information required when drawing up the invoice is for example the name and address of the buyer. The merchant also has the option of sending the invoice by e-mail, but this assumes that the customer has provided his e-mail address beforehand, for example by subscribing to the merchant's loyalty program. This invoice may then be used as a supporting document for having the supplier of the product take responsibility for a repair or having the purchase refunded by the buyer's company. The invoice usually remains in paper form and may be misplaced, stolen or even destroyed. There is no solution for automating the digitization of an invoice by a merchant for a new customer.

### 3. DISCLOSURE OF THE INVENTION

The invention aims to improve the prior art and proposes a method for the transmission, by a transmission device, to at least one electronic address managed by at least one server, of at least one additional item of information relating to at least one financial transaction conducted by a user, said device being characterized in that the method comprises:

a step of receiving, from a terminal, at least one first message relating to at least one financial transaction, said message comprising at least one identifier of said user,

a step of determining at least one electronic address on the basis of said at least one identifier,

a step of obtaining at least one additional item of information,

a step of generating at least one second message comprising said at least one additional item of information,

a step of transmitting, within a time interval, said at least one second message to said at least one electronic address.

Advantageously, this method allows a user to obtain, in a financial transaction, additional information about his purchase, such as the seller's company name or his address, and to be able to consult said information for example using an electronic messaging account or in his online account statement. Indeed, when a user conducts a financial transaction, such as for example a payment to a seller, the device will securely retrieve, from a terminal of the merchant, an identifier of the user, such as for example a digital representation of a biometric feature of the user (i.e. of the customer) or else the PAN (Primary Account Number), that is to say the 16 or 19 digits written on the bank card used in the payment and retrieved by the electronic payment terminal. A unique e-mail address is then forged from the identifier. In the case of a bank card payment via an electronic payment terminal, the address is for example an address used by the user's bank, the “domain” part of which is deduced from the first 8 digits of the PAN, which make it possible to identify the institution issuing the card. The device will also obtain all of the desired additional information, such as for example a unique transaction number, the date and time or even a postal address of the user on the basis of the retrieved identifier. The device will then generate a new message that will include the obtained and/or received information.

The new message is then sent to the forged electronic address, within a time interval that may for example be a few seconds after the transaction or even a few minutes starting at a specific time, such as for example at the start of the remote banking collection performed by the terminal if this is an electronic payment terminal. This makes it possible to ensure a certain amount of security. Indeed, any message received outside of the time interval will not be taken into account by the server. Once the message has been received by the server, it may for example be consulted by the user via the electronic messaging account associated with the generated electronic address, but also, in the case of a banking transaction via for example an electronic payment terminal, be processed by a server of the bank so as to enrich the user's online account statement. The server then provides an account statement in which the transaction lines are associated with additional information received from the device at the time of the transaction. The account statement presented to the user is thereby more explicit and is made easier to read. Furthermore, this method also makes it possible to automate the reimbursement of an employee's expense reports by his company when he uses his business bank card. Indeed, the company will have all of the invoices associated with its employee's expenses directly on the business account statement. Accounting is thereby made much easier.

A terminal is understood to mean any terminal for obtaining an identifier of a user, such as an Electronic Payment Terminal (EPT) capable of reading for example information present on a bank card, a computer capable of displaying, for example using an Internet browser, a form for example for inputting an identifier, a biometric sensor such as a camera for performing facial recognition, or even a barcode reader.

According to one particular mode of implementation of the invention, a method as described above is characterized in that the step of generating said second message is conditional upon the result of a validation step performed by said user, through a human-machine interface of said device.

This mode of implementation makes it possible to leave the user the choice as to whether or not to generate a second message comprising additional information, such as for example an invoice associated with the current purchase.

According to a first variant of this particular embodiment of the invention, a method as described above is characterized in that the validation is performed through a voice command.

This mode of implementation makes it possible to validate or not validate the generation of an invoice via a voice command.

According to a second variant of this particular embodiment of the invention, a method as described above is characterized in that the validation is obtained after biometric authentication of said user.

This mode of implementation makes it possible to validate or not validate the generation of an invoice via biometric authentication of the user, such as a fingerprint, facial recognition, voice recognition or even iris recognition.

According to one particular mode of implementation of the invention, a method as described above is characterized in that the identifier is a digital representation of a biometric feature of said user.

This mode of implementation makes it possible, through a digital representation of a biometric feature such as the voice, a fingerprint, an iris, or even a face, to obtain an identifier associated with the user.

According to one particular mode of implementation of the invention, a method as described above is characterized in that the identifier is an item of data stored on a bank card of said user.

This mode of implementation makes it possible for example to use the PAN and/or the name written on the bank card as identifier of the user.

According to one particular mode of implementation of the invention, a method as described above is characterized in that said at least one second message comprises an invoice for at least one purchase associated with the financial transaction.

This mode of implementation makes it possible to automate the generation of an invoice when making a purchase from a seller. An invoice is understood to mean an accounting document attesting to the purchase of at least one tangible or intangible product by a customer from a seller. For an invoice to be valid, it must include certain fields, such as for example those defined by the European standard AFNOR NF EN 16931-1.

According to one variant of this particular embodiment of the invention, the method as described above is characterized in that the generation step is conditional upon the result of a validation step performed by said user for said at least one purchase associated with the financial transaction, through a human-machine interface of said device.

This mode of implementation allows the user to select the additional information present in the second message on the basis of the items purchased in the financial transaction. This makes it possible for example to draw up an invoice for a subset of the purchased products.

According to one particular mode of implementation of the invention, a method as described above is characterized in that the transmission step is followed by a step of receiving at least one third message from said at least one server.

This mode of implementation allows the device to receive for example an acknowledgement of receipt following the transmission of the second message. This mode of implementation also makes it possible, when the time interval follows the financial transaction, to have a real-time interaction between the device and the server, which executes for example a conversational assistant.

According to one particular mode of implementation of the invention, a method as described above is characterized in that said at least one additional item of information is obtained via a human-machine interface of said device.

This mode of implementation allows for example the user and/or seller to enter additional information directly on the device, such as for example postal address, name, date, etc.

The invention also relates to a device for transmitting, to at least one electronic address managed by at least one server, at least one additional item of information relating to at least one financial transaction conducted by a user, and characterized in that the device comprises:

a reception module for receiving, from a terminal, at least one first message relating to at least one financial transaction and comprising at least one identifier of said user,

a determination module for determining at least one electronic address on the basis of said at least one identifier,

an obtainment module for obtaining said at least one additional item of information,

a generation module for generating at least one second message comprising said at least one additional item of information,

a transmission module for transmitting, within a time interval, said at least one second message to said at least one electronic address.

The term module may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly able to implement a function or a set of functions for the module in question (integrated circuit, chip card, memory card, etc.).

The invention also relates to an electronic payment terminal, characterized in that it comprises a device for transmitting at least one additional item of information relating to at least one financial transaction conducted by a user.

The invention also relates to a system for transmitting, to at least one electronic address managed by at least one server, at least one additional item of information relating to at least one financial transaction conducted by a user, said system being characterized in that it comprises:

a transmission device as described above,

a server capable of receiving and processing, within a time interval, said at least one second message from said device and intended for said at least one electronic address managed by said server, said second message comprising said at least one additional item of information.

This mode of implementation allows the server, for example, when receiving the second message, to process it and return it for example to another server, such as a bank server or an institutional server.

According to one variant of this particular embodiment of the invention, the system as described above is characterized in that the server is a messaging server and/or an automated conversational system.

This mode of implementation makes it possible to transmit the second message to a messaging server such as an e-mail, instant messaging or SMS/MMS server, allowing the user or an authorized entity to consult and/or to process the message. If the server is a conversational system, this mode of implementation makes it possible for example to automate the processing of the content of the second message and to interact with the device and ultimately the user. The conversational system may thus question the user via a natural-language interface, for example on the form and the content of the second message.

The invention also relates to a computer program comprising instructions for implementing the above method according to any one of the particular embodiments described above when said program is executed by a processor. The method may be implemented in various ways, in particular in hard-wired form or in the form of software. This program may use any programming language and be in the form of source code, object code or intermediate code between source code and object code, such as in a partially compiled form, or in any other desirable form.

The invention also targets a computer-readable recording medium or information medium containing instructions of a computer program such as mentioned above. The abovementioned recording media may be any entity or device capable of storing the program. For example, the medium may comprise a storage means, such as a ROM, for example a CD-ROM or a microelectronic circuit ROM, or else a magnetic recording means, for example a hard disk. Moreover, the recording media may correspond to a transmissible medium such as an electrical or optical signal, which may be routed via an electrical or optical cable, by radio or by other means. The programs according to the invention may in particular be downloaded from an Internet network.

As an alternative, the recording media may correspond to an integrated circuit in which the program is incorporated, the circuit being designed to execute or to be used in the execution of the method in question.

This device for transmitting at least one additional item of information relating to at least one financial transaction conducted by a user and this computer program have features and advantages analogous to those described above in relation to the method for transmitting at least one additional item of information relating to at least one financial transaction conducted by a user.

### 4. LIST OF THE FIGURES

Other features and advantages of the invention will become more clearly apparent upon reading the following description of particular embodiments, provided by way of simple illustrative and nonlimiting examples, and the appended drawings, in which:

FIG. 1 illustrates an example of an environment for implementing the invention, according to one particular embodiment of the invention,

FIG. 2 illustrates a second example of an environment for implementing the invention, according to one particular embodiment of the invention,

FIG. 3 illustrates the main steps of the method for transmitting at least one additional item of information relating to at least one financial transaction conducted by a user,

FIG. 4 illustrates the architecture of a device designed to implement the method for transmitting at least one additional item of information relating to at least one financial transaction conducted by a user.

### 5. DESCRIPTION OF ONE EMBODIMENT OF THE INVENTION

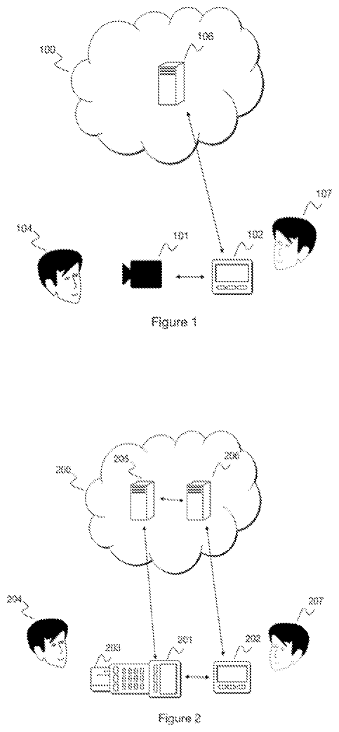

FIG. 1 illustrates an example of an environment for implementing the invention, according to one particular embodiment of the invention. The environment shown in FIG. 1 comprises a terminal 101, such as a camera or a fingerprint reader, capable of obtaining an identifier of a user, such as for example a digital representation of a biometric feature, and a device 102 for transmitting at least one additional item of information relating to at least one financial transaction. The terminal 101 and the device 102 are connected to a communication network 100, such as for example an Internet network or else a private network, via an access network, not shown here. The access network may be a Wi-Fi network or a 2G, 3G or 4G cellular data network. The network 100 comprises a messaging server 106 designed to exchange messages with the device 102, such as for example e-mails, instant messages conforming for example to the RCS (Rich Communication Suite) standard, SMS (Short Message Service), or any other desirable message. The server 106 may implement a virtual assistant, a conversational agent (or “chatbot”) designed to communicate with the device 102 through natural-language instant messaging.

In a financial transaction conducted between the user 104 and the seller 107, for example a cash payment, the device 102 will securely retrieve an identifier of the user 104 from the terminal 101. In this example, with the terminal 101 being a camera, the identifier retrieved by the device 102 is a digital representation of the face of the user 104 (i.e. of the customer). The device 102 will also obtain all of the desired additional information, such as for example a unique transaction number, the date and time or even a postal address of the user on the basis of the identifier. This information may for example be stored in an internal memory of the device, entered by the user 104 or the merchant 107 by way of a suitable human-machine interface present on the device such as a keypad/touchscreen or a microphone linked to voice recognition software, or even retrieved from a server located in the network.

The device 102 will generate a new message that will include the obtained and/or received information. The new message is then sent to the forged electronic address, within a time interval that may for example start at a specific time. This thus makes it possible to ensure a certain amount of security. Indeed, any message received outside of the time interval will not be taken into account by the messaging server 106 that manages the forged electronic address. Once the message has been received by the messaging server 106, it may for example be consulted by the user via the electronic messaging account associated with the generated electronic address.

Of course, FIG. 1 is a simplified representation of such an architecture. Under real conditions, the architecture may comprise other elements and interactions that are more complex than those described above. Such an architecture is also described by way of illustrative example. This architecture is not limiting, and other architectures are suitable for implementing the invention. For example, the terminal 101 may also comprise the device 102 for transmitting at least one additional item of information relating to at least one financial transaction. In this implementation case, the identifier of the user will be received by the device 102 via messages internal to the terminal 101.

It is also understood that all of the messages exchanged between for example the terminal 101 and the device 102, the device 102 and the messaging server 106 may be messages that are encrypted/ciphered via for example private/public key encryption mechanisms. The networks used to exchange these messages may also be an Internet network or else a private network.

FIG. 2 illustrates a second example of an environment for implementing the invention, according to one particular embodiment of the invention. The environment shown in FIG. 2 comprises an electronic payment terminal 201 and a device 202 for transmitting at least one additional item of information relating to at least one financial transaction. The electronic payment terminal 201 and the device 202 are connected to a communication network 200, such as for example the Internet or a private network of a banking institution, via an access network, not shown here. The access network may be a Wi-Fi network or a 2G, 3G or 4G cellular data network. The network 200 comprises a bank server 205 designed to record and process the banking transactions conducted by the merchant from the electronic payment terminal 201. The network 200 also comprises a messaging server 206 designed to exchange messages with the device 202, such as for example e-mails, instant messages conforming for example to the RCS (Rich Communication Suite) standard, SMS (Short Message Service), or any other desirable message. The server 206 may implement a virtual assistant, a conversational agent (or “chatbot”) designed to communicate with the device 202 through natural-language instant messaging.

FIG. 2 also shows a payment means 203 belonging to a user 204. The user 204 makes a payment using his payment means 203 and the merchant's electronic payment terminal 201. The payment means shown here is a bank card, but the invention applies to any payment means, such as for example an NFC (Near Field Communication) payment means, a virtual bank card or a check. The NFC payment means may be a bank card comprising a contactless payment module or a mobile terminal when it is equipped with an NFC contactless payment module.

The messaging server 206 is connected to the bank server 205 and may transmit and receive messages thereto and therefrom. In particular, the messaging server 206 may transmit the messages from the device 202 to the bank server 205 when a banking transaction is conducted. For this purpose, a user account on the messaging server is associated with a bank account on the server 205. The association is for example made by way of an identifier belonging to the user 204, such as the PAN (Primary Account Number) of his bank card or else the digital representation of a biometric feature (face, iris, fingerprint, etc.) of the user 204. This identifier, which is known to the bank server 205, is transmitted by the payment terminal 201 to the device 202 and then sent by the device 202 to the server 206. Thus, when a banking transaction is conducted between the electronic payment terminal 201 and the server 205, a message is transmitted to the messaging server 206 by the device 202, comprising additional information to the transaction, but also the identifier of the user 204 retrieved from the electronic payment terminal 201. The message sent by the device 202 to the server 206 may also contain other information present in the first message exchanged between the payment terminal 201 and the device 202. This may for example be a transaction identifier, the identifier of the payment terminal or else an identifier of the merchant. The server 206 may then use this information to transmit one or more features of the transaction to the server 205.

Of course, FIG. 2 is a simplified representation of such an architecture. Under real conditions, the architecture may comprise other elements and interactions that are more complex than those described above. Such an architecture is also described by way of illustrative example. This architecture is not limiting, and other architectures are suitable for implementing the invention. For example, the servers 205 and 206 may be one and the same server. The payment terminal 201 may also comprise the device 202 for transmitting at least one additional item of information relating to at least one financial transaction. In this implementation case, the identifier of the user will be received by the device 202 via messages internal to the terminal 201. This same terminal may also be contained within a computer or any other device having the architecture of a computer, such as a smartphone, a tablet, a voice assistant, etc., thus making it possible to address online purchases. In the case of this mode of implementation, the user will for example input the information present on his bank card on for example an interface displayed by an Internet browser in order to make a payment. The computer will then generate an e-mail address using the information provided by the user, such as the PAN and the CVV (Card Validation Value). He will also, beforehand, have obtained all of the additional information required to form a message that is sent thereafter to the messaging server 206.

It is also understood that all of the messages exchanged between for example the payment terminal 201 and the bank server 205, the payment terminal 201 and the device 202, the device 202 and the messaging server 206 and between the messaging server 206 and the server 205 may be messages that are encrypted/ciphered for example via private/public key encryption mechanisms. The networks used to exchange these messages may also be an Internet network or else a private network, for example operated by the merchant's bank.

According to one particular embodiment of the invention, the user 204 may access a user account specific to him on the messaging server 205 and consult the messages sent by the device 202.

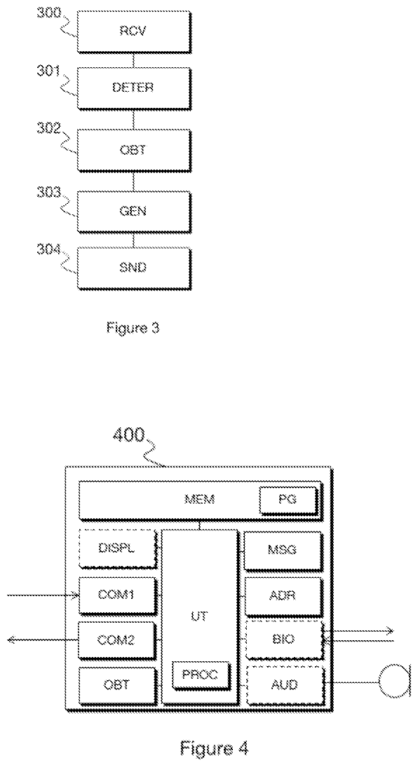

FIG. 3 illustrates the main steps of the method for transmitting at least one additional item of information relating to at least one financial transaction conducted by a user, according to either of the particular embodiments of the invention presented above. The method is executed on the device for transmitting at least one additional item of information relating to at least one financial transaction conducted by a user.

In a first step 300, the method receives, from the terminal, such as for example the payment terminal 201, a first message comprising at least one identifier of the user who has just made a purchase from a merchant. The identifier is for example an item of data stored on the bank card, such as the PAN (Primary Account Number) or else a digital representation of a biometric feature (face, iris, fingerprint, etc.) of the user, or any other identifier for identifying the user. If the terminal is an electronic payment terminal, and the identifier is a digital representation of a biometric feature, this of course means that the user has enrolled beforehand with an authorized entity, such as for example his bank, thus making it possible to correlate his identity and the digital representation of the biometric feature that is used. However, this prior enrolment is not necessary if the identifier happens to be the PAN of the user's bank card. Indeed, since the bank issues the card, it knows the identity of the user associated therewith. The first message may also contain other information, such as for example the name of the user, the price, the date and time of the transaction, the number of the transaction, the status of the transaction or else any other relevant information linked to the banking transaction performed by the user 204.

In step 301, the method will determine an e-mail address using the identifier received in step 300. The “local” part of the address may for example correspond to the whole identifier or to a subset of the identifier. With regard to the “domain” part of the address, this may for example be a subset of the identifier, or else determined by part of the identifier or even a predefined character string. The “domain” part of the address may also be a concatenation of the identifier or of a subset of the identifier with a predefined character string.

With an e-mail address being formed as follows, “local part”@“server address or domain name”, the e-mail address, if the terminal is a bank terminal allowing payment with a bank card, may be:

“PAN”@ “the 1st 8 digits of the PAN”.com

The domain name is used to identify, via the Simple Mail Transfer Protocol (SMTP), the messaging server that will host the recipient mailbox. The domain name is transformed into an IP address through the DNS name resolution system. The local part is for its part specific to this server, and identifies the mailbox as such.

In step 302, the method will obtain at least one additional item of information relating to the transaction conducted by the user. This information may for example be stored in an internal memory of the device, present in the first message received from the payment terminal or else entered by the user or the merchant by way of a suitable human-machine interface present on the device such as a keypad/touchscreen or a microphone linked to voice recognition software, or even retrieved from the network, such as for example from the user's bank. This additional information may for example be the user's postal address, a transaction identifier, a specific description or any other information for example required for a merchant to draw up an invoice, such as for example taxes or the company name and the address of the merchant.

In a step 303, the method will generate a second message with all of the desired information. This message comprises at least one additional item of information associated with the financial transaction conducted and obtained in step 302. The second message may also contain information received by way of the first message sent by the terminal to the device. The information may also be linked to a subset of the financial transaction. For example, if a user purchases multiple items, the information contained in the second message may relate only to a subset of the purchased items. This subset may be determined automatically, for example on the basis of the reference of the purchased item or on the basis of a choice made by the user.

Indeed, according to one particular embodiment of the invention, step 303 may be conditional upon the result of a validation step performed by the user, through a human-machine interface of the device. The user may thus choose whether or not to generate the second message for a given financial transaction.

The user may also select the information present in the second message through a human-machine interface of the device. This makes it possible for example to draw up an invoice for a subset of the products purchased in the financial transaction. This validation may take place for example using a keypad/touchscreen interface, voice recognition, or even biometric identification of the user (fingerprint, iris, face, etc.).

In step 304, the method will transmit the second message to the messaging server. The message may then be consulted by the user from a dedicated interface, such as for example messaging software, or else processed by the messaging server and/or retransmitted for example to a bank server in order to enrich for example the user's account statement. The method thus makes it possible to produce a statement of the user's banking transactions in which the transactions are associated with additional information, such as for example invoices.

According to one particular embodiment of the invention, step 304 may be followed by a step of receiving a message from the messaging server 206. This message is for example an acknowledgement of receipt of the previous message or else a message comprising data for interacting with the user.

FIG. 4 illustrates a device 400 configured so as to implement the method for transmitting at least one additional item of information relating to at least one financial transaction conducted by a user according to one particular embodiment of the invention. The device 400 corresponds for example to the device 102 of FIG. 1 or to the device 202 of FIG. 2.

According to one particular embodiment of the invention, the device 400 has the conventional architecture of a mobile telephone, such as a smartphone or tablet, and comprises in particular a memory MEM, a processing unit UT, equipped for example with a processor PROC, and driven by the computer program PG stored in memory MEM. The computer program PG comprises instructions for implementing the steps of the method for transmitting at least one additional item of information relating to at least one financial transaction conducted by a user as described above when the program is executed by the processor PROC.

On initialization, the code instructions of the computer program PG are for example loaded into a memory, before being executed by the processor PROC. The processor PROC of the processing unit UT in particular implements the steps of the method for transmitting at least one additional item of information relating to at least one financial transaction conducted by a user according to any one of the particular embodiments described with reference to FIGS. 1, 2 and 3 according to the instructions of the computer program PG.

The device 400 comprises a communication module COM1 configured so as to establish communications with an IP and/or circuit-switched or point-to-point network (Wi-Fi, Bluetooth, infrared, etc.) in order to obtain, for example from the electronic payment terminal 201, at least one first message comprising at least one identifier of the user 204. The device 400 also comprises a module ADR capable of determining an e-mail address on the basis of the retrieved identifier, a module OBT capable of obtaining at least one item of information additional to the banking transaction conducted by the user on the electronic payment terminal 201, and a module MSG capable of generating a second message with at least one additional item of information obtained by the module OBT.

It should be noted that the additional information may be provided by the user for example through input on an input peripheral device such as a touchscreen (DISPL) or a keypad, or picked up by a microphone and interpreted by an audio module (AUD) and voice recognition software, if the user uses voice.

Once the message has been generated, it is sent, by way of the module COM2, to the e-mail address determined by the module ADR to the messaging server that manages this address.

Such an architecture is described by way of illustrative example. This architecture is not limiting, and other architectures are suitable for implementing the invention. For example, the modules COM1 and COM2 may be one and the same module.

According to one particular embodiment of the invention, the device may offer a human-machine interface allowing the user to validate or not validate the generation of the second message. The user may thus choose whether or not to generate the second message for a given transaction. This validation may for example take place using the module DISPL, which will offer an input interface on a touchscreen, the module AUD, which will allow voice recognition to be performed, or even the module BIO, which will allow a biometric identification of the user (fingerprint, iris, face, etc.) to be managed.

It goes without saying that the embodiment that has been described above has been given purely by way of wholly non-limiting indication, and that numerous modifications may easily be made by those skilled in the art without, however, departing from the scope of the invention.

1. A method performed by a transmission device and comprising:
receiving, from a terminal, at least one first message relating to at least one financial transaction conducted by a user, said message comprising at least one identifier of said user;
determining at least one electronic address on the basis of said at least one identifier, the at least one electronic address being managed by at least one server;
obtaining at least one additional item of information relating to the at least one financial transaction;
generating at least one second message comprising said at least one additional item of information; and
transmitting, within a time interval, said at least one second message to said at least one electronic address.

2. The method as claimed in claim 1, wherein the generating said second message is conditional upon a result of a validation performed by said user through a human-machine interface of said device.

3. The method as claimed in claim 2, comprising receiving the validation through a voice command.

4. The method as claimed in claim 2, wherein comprising receiving the validation through biometric authentication of said user.

5. The method as claimed in claim 1, wherein the identifier is a digital representation of a biometric feature of said user.

6. The method as claimed in claim 1, wherein the identifier is an item of data stored on a bank card of said user.

7. The method as claimed in claim 1, wherein said at least one second message comprises an invoice for at least one purchase associated with the financial transaction.

8. The method as claimed in claim 7, wherein the generating is conditional upon a result of a validation performed by said user for said at least one purchase associated with the financial transaction, through a human-machine interface of said device.

9. The method as claimed in claim 1, wherein the transmitting is followed by receiving at least one third message from said at least one server.

10. The method as claimed in claim 1, comprising obtaining said at least one additional item of information via a human-machine interface of said device.

11. A device comprising:
a receiver;
a transmitter;
a processor; and
a non-transitory computer-readable medium comprising instructions stored thereon which when executed by the processor configure the device to:
receive, from a terminal, at least one first message relating to at least one financial transaction conducted by a user and comprising at least one identifier of said user;
determine at least one electronic address on the basis of said at least one identifier, the at least one electronic address being managed by at least one server;
obtain at least one additional item of information relating to the at least one financial transaction;
generate at least one second message comprising said at least one additional item of information; and
transmit, within a time interval, said at least one second message to said at least one electronic address.

12. The device as claimed in claim 11, wherein the device is an electronic payment terminal.

13. A system comprising:
a transmission device comprising:
a receiver;
a transmitter;
a processor; and
a non-transitory computer-readable medium comprising instructions stored thereon which when executed by the processor configure the transmission device to:
receive, from a terminal, at least one first message relating to the at least one financial transaction conducted by a user and comprising at least one identifier of said user;
determine at least one electronic address on the basis of said at least one identifier, the at least one electronic address being managed by a server;
obtain at least one additional item of information relating to the at least one financial transaction;
generate at least one second message comprising said at least one additional item of information; and
transmit, within a time interval, said at least one second message to said at least one electronic address; and
the server, which is configured to receive and process, within the time interval, said at least one second message from said device and intended for said at least one electronic address managed by said server, said second message comprising said at least one additional item of information.

14. The system as claimed in claim 13, wherein the server is a messaging server or an automated conversational system.

15. A non-transitory computer-readable medium comprising a computer program stored thereon and comprising instructions for implementing a transmission method when the program is executed by a processor of a transmission device, therein the instructions configure the transmission device to:
receive, from a terminal, at least one first message relating to at least one financial transaction conducted by a user, said message comprising at least one identifier of said user;
determine at least one electronic address on the basis of said at least one identifier, the least one electronic address being managed by at least one server;
obtain at least one additional item of information relating to the at least one financial transaction;
generate at least one second message comprising said at least one additional item of information; and
transmit, within a time interval, said at least one second message to said at least one electronic address.
